(19) United States
(12) Patent Application Publication
(10) Pub. No.: US 2006/0275030 A1
(43) Pub. Date: Dec. 7, 2006

(54) Multi-environment object movement system and method

(76) Inventor: Jim Rodnunsky, Granada Hills, CA (US)

Correspondence Address: DALINA LAW GROUP, P.C., 7910 IVANHOE AVE. #325, LA JOLLA, CA, 92037, US

(21) Appl. No.: 11/145,555

(22) Filed: Jun. 3, 2005

(51) Int. Cl. G03B 17/00

(52) U.S. Cl. 396/428

(57) ABSTRACT

One or more embodiments of the invention enable the movement of an object through multiple environments such as liquid and gas for example using rope or cable. Various objects can be moved using one or more embodiments of the invention such as a human or camera for example. Displacing a camera vertically between environments while moving the camera horizontally allows for highly stable motion pictures to be taken using one or more embodiments of the invention. To enable this type of movement, embodiments of the invention are configured to move an object by relocating one or more lines that are coupled to a plurality of sides of the object. The lines can be any type of flexible connective material such as rope, cable, string, cord, wire or any other similar material.

### BACKGROUND OF THE INVENTION

1. Field of the Invention

Embodiments of the invention described herein pertain to the field of cable rail systems. More particularly, the embodiments described herein enable the movement of objects such as a camera using cable or rope through multiple environments such as liquid and gas.

2. Description of the Related Art

There are no known systems that can move objects along a path through multiple environments such as liquid and gas. Known systems are capable of moving an object through air or through water, but not both. Systems that can move objects through air allow support an object from above using cable for example. Systems that move objects through the water using cables either suspend an object from the surface of the water (i.e., from above) or suspend a buoyant object by restraining the object from below. There are no known systems that are capable of stable movement a suspended object when the object leaves one environment and enters another. For example, if an object is moved at a given rate of speed horizontally through the air and the object enters the water, then the speed of the object is reduced and the movement of the object is limited based on the buoyancy of the particular object. Many other problems exist when attempting to provide stable speeds regardless of the environment. This limits the usefulness of cameras tracking certain objects through the air and water for example. For at least the limitations described above there is a need for system that can move objects through multiple environments.

### BRIEF SUMMARY OF THE INVENTION

One or more embodiments of the invention enable the movement of an object through multiple environments such as liquid and gas for example using rope or cable. Various objects can be moved using one or more embodiments of the invention such as a human or camera for example. Displacing a camera vertically between environments while moving the camera horizontally allows for highly stable motion pictures to be taken using one or more embodiments of the invention.

To enable this type of movement, embodiments of the invention are configured to move an object by relocating one or more lines that are coupled to a plurality of sides of the object. The lines can be any type of flexible connective material such as rope, cable, string, cord, wire or any other similar material.

The exact reeving or arrangement of the lines is dependent upon the embodiment of the invention. In each embodiment at least two opposing sides of an object are coupled in the vertical axis to allow for upward and downward forces to constraint the vertical displacement of the object. This also provides stability for the dynamic entry and exit from one environment to another. Bull wheels are generally used to displace line from one side of the system to the other. This may include horizontal axis displacement (X-axis) and vertical displacement (Z-axis). In other embodiments utilizing three-dimensional positioning capabilities, a Y-axis displacement is also enabled.

For example, although the embodiments shown in the attached figures describe a reeving that allows for independent movement of X and Z axes, other reevings can also provide such capabilities that any combination of the reevings enabled in the following applications may be utilized in the upper or lower portion of the system to achieve two or three dimensional movement capabilities. For example, a reeving found in U.S. patent application Ser. No. 10/368,137 may be used to couple with the top portion of a platform while the lower portion of the platform may utilize embodiments described in the detailed description below. Alternatively, the lower portion of a platform may be coupled with the reeving found in any of the following applications while the upper portion may utilize the reevings described herein. U.S. patent application Ser. No. 10/368,137 now U.S. Pat. No. 6,886,471 is hereby incorporated herein by reference. U.S. patent application Ser. No. 10/604,525 now U.S. Pat. No. 6,809,495 is hereby incorporated herein by reference. U.S. patent application Ser. No. 10/604,667, filed Aug. 8, 2003 is hereby incorporated herein by reference. U.S. patent application Ser. No. 10/605,778, filed Oct. 25, 2003 is hereby incorporated herein by reference. U.S. patent application Ser. No. 10/708,158, filed Feb. 12, 2004 is hereby incorporated herein by reference. U.S. patent application Ser. No. 10/709,918, filed Jun. 4, 2004 is hereby incorporated herein by reference. U.S. patent application Ser. No. 10/709,994, filed Jun. 8, 2004 is hereby incorporated herein by reference. U.S. patent application Ser. No. 10/906,621, filed Feb. 27, 2005 is hereby incorporated herein by reference.

### BRIEF DESCRIPTION OF THE DRAWINGS

FIG. 1 illustrates a side view of the reeving of a two-dimensional embodiment of the invention utilizing a hydrodynamic truss configured to travel horizontally across the written page with an object traveling vertically up and down the written page.

FIG. 2 illustrates a side view of the reeving of a two-dimensional embodiment of the invention that moves a hydrodynamic object without the use of a hydrodynamic truss.

FIG. 3 illustrates an isometric view of the truss and dolly employing externally reeved lines.

FIG. 4 illustrates an isometric view of the truss and dolly employing internally reeved lines.

FIG. 5 illustrates an isometric view of the hydrodynamic object shown in FIG. 2.

### DETAILED DESCRIPTION OF THE INVENTION

A multi-environment object movement system and method will now be described. In the following exemplary description numerous specific details are set forth in order to provide a more thorough understanding of embodiments of the invention. It will be apparent, however, to an artisan of ordinary skill that the present invention may be practiced without incorporating all aspects of the specific details described herein. In other instances, specific features, quantities, or measurements well known to those of ordinary skill in the art have not been described in detail so as not to obscure the invention. Readers should note that although examples of the invention are set forth herein, the claims, and the full scope of any equivalents, are what define the metes and bounds of the invention.

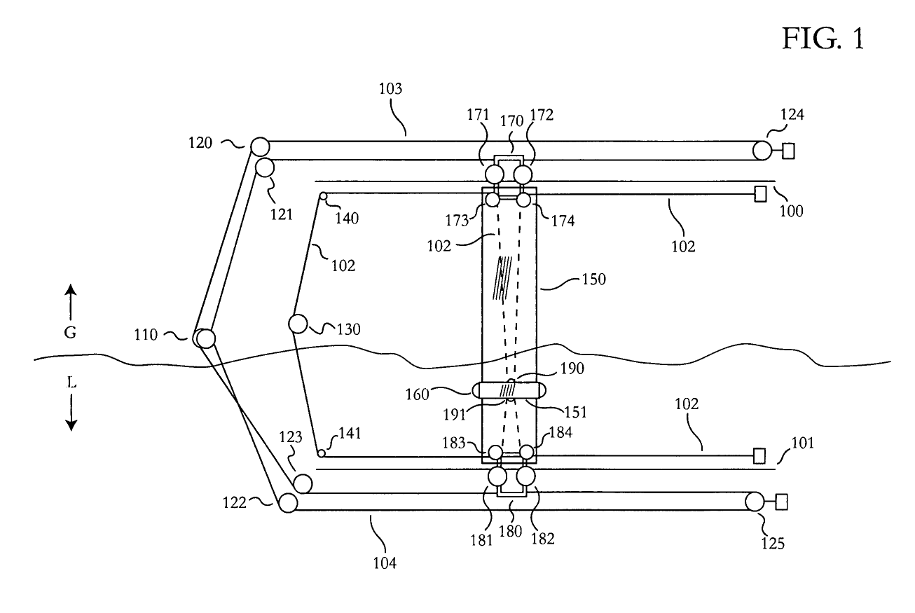

FIG. 1 shows an embodiment of the invention having two environments G and L, wherein G stands for gaseous and L stands for liquid environments respectively. Platform 151 in the center of the figure is the object or is coupled to the object to be moved using this embodiment of the invention.

Platform 151 may move vertically up and down the written page when Z movement line 102 is moved from one side of platform 151 to the other. For instance when Z movement motor 130 rotates counterclockwise line 102 flows down from sheave 140 from sheave 173 and from sheave 190 (coupled with the upper side of platform 151). While line 102 is moving in this direction, line 102 is also moving into sheave 141 into sheave 183 and into sheave 191 (coupled with the lower side of platform 151). In this manner, platform 151 ascends vertically. By rotating Z movement motor 130 in the clockwise direction, platform 151 descends vertically. By rotating Z movement motor 130, the X axis displacement of platform 151 does not change. This means that the Z axis movement is independent of the X axis movement. Moving the platform vertically allows for multiple environments such as liquid and gaseous environments to be traversed.

Platform 151 may move horizontally (left and right) along the written page when X movement lines 103 and 104 are moved from one side of platform 151 to the other. For instance when X movement motor 110 rotates counterclockwise line 103 flows down from sheave 120 from sheave 124 which pulls skate 170 (coupled with the right side of platform 151) to the right. The bull wheel driving X movement line 103 moves line 103 up into sheave 121 which allows skate 170 to travel to the right. While the X movement motor is rotating in the counterclockwise direction, line 104, coupled with a second bull wheel driven by X movement motor 110 moves line 104 from sheave 122 from sheave 125 which pulls skate 180 (coupled with the right side of platform 151 via the Z movement line 102) to the right. While line 104 exits the bull wheel coupled to X movement motor 110 it enters sheave 123 which allows skate 180 to travel to the right. In this manner, platform 151 is pulled to the right in the figure. By rotating X movement motor 110 in the clockwise direction, platform 151 moves to the left in the figure. By rotating X movement motor 110, sheaves 173, 190, 174 and 183, 191, 184 to travel freely allowing the Z axis displacement of platform 151 to remain constant. This means that the X axis movement is independent of the Z axis movement.

During X axis movement, tracks 100 and 101 allow for rollers or sheaves 171, 172, 181 and 182 to roll or travel along tracks 100 and 101. The tracks may be rigid or highlines under tension depending upon the particular requirements of the implementation.

Z movement line 102 may be doubled-up so that both sides of the platform, namely the side nearest the reader and the side beneath the written page are acted upon. In addition, embodiments of the truss 150 allow for at least one groove to allow for internal reeving of line 102 so that the line is housing within truss 150. Truss 150 may be hydrodynamically shaped allowing for ease of X axis traversal while platform 151 may also be hydrodynamically shaped.

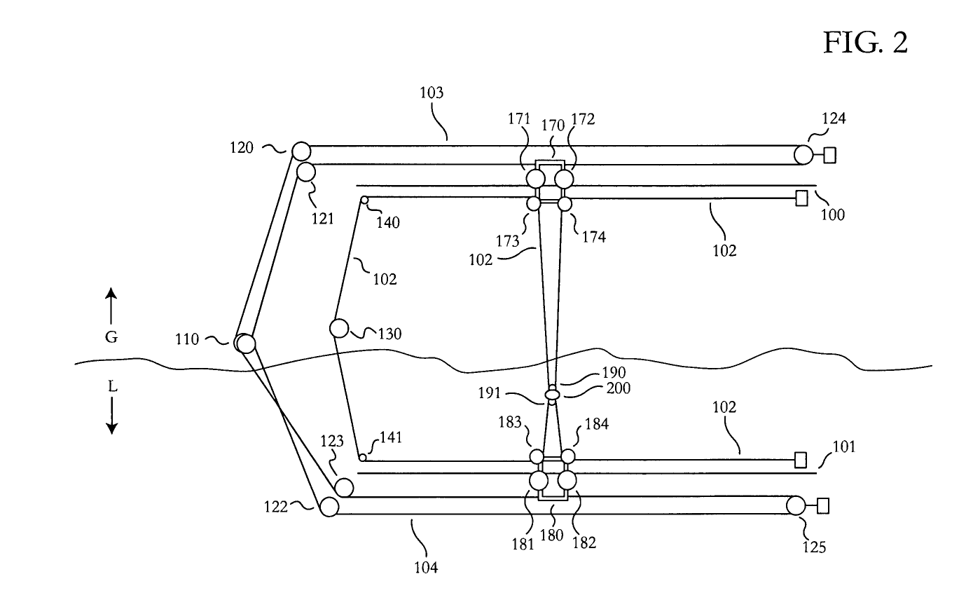

FIG. 2 shows another embodiment of the invention that does not use a truss. In this embodiment of the invention, platform 200 is coupled with sheaves 190 and 191 and moves vertically and horizontally in the same manner as described with respect to FIG. 1. In other words, X axis and Z axis movement is accomplished by moving X axis and Z axis motors in the same direction to affect the same direction of movement in this embodiment as well. Although high speed X axis movement may yield cavitation effects, since sheaves 190 and 191 provide a Z axis displacement above and below platform 151, a camera for example would not view the low pressure bubbles unless panned into a vertical orientation.

Skate 180 may comprise a hydrodynamically shaped enclosure in one or more embodiments of the invention. Sheaves 190 and 191 may comprise generating elements that allow for power to be derived within platform 200 (or 151 in FIG. 1). A video camera housed in any platform embodiment may comprise a pre-programmed shot sequence or may comprise an input that allows for complete control of all camera operations and may comprise the video signal from the camera output as well.

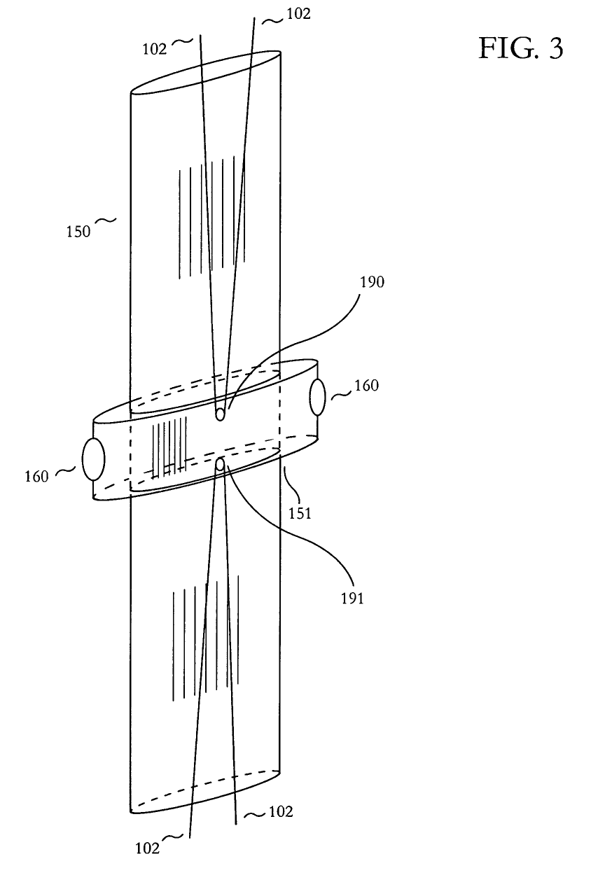

FIG. 3 shows an embodiment of the truss and platform of FIG. 1. Truss 150 in this embodiment is hydrodynamically shaped so that movement through a liquid environment requires less power, achieves greater speeds for a given X movement motor and allows for smaller X movement motors to be deployed for a desired application requiring a specified speed. In this embodiment, forward and rear pointing enclosures 160 are shown on opposing sides of the platform. Z movement line 102 is shown descending vertically to sheave 190 and ascending vertically to sheave 191 from below. As the sheaves are mounted on the outside of platform 151 in this example any mechanism for providing low friction traversal of platform 151 up and down truss 150 is in keeping with the spirit of the invention. For instance, rollers or bearings between the inside of platform 151 and the outside of truss 150 may be used in various embodiments of the invention to provide smoother vertical travel depending upon the application requirements. Forward and rear pointing enclosures 160 may be utilized in housing sensors such as a camera for example.

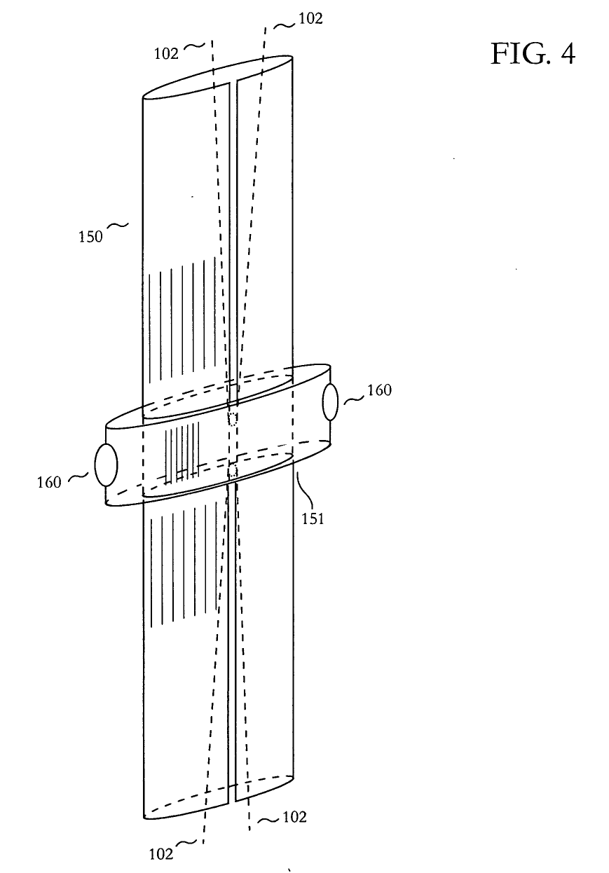

FIG. 4 shows an embodiment of the invention comprising a groove in truss 150 on the nearest face of truss 150. This allows for sheaves 190 and 191 to be internally mounted which therein allows Z movement line 102 to travel unimpeded through space without interacting with the environment(s) that that platform is currently in. Many different variations of the internal mounting are in keeping with the spirit of the invention. For example, Z movement line 102 may be doubled-up by allowing for two grooves, one on each opposing face of truss 150 that would allow for a more even pull-up or pull-down of platform 151. In this configuration, a connector between the furthest points in the truss substantially parallel to the faces of the truss would allow for two grooves. Although platform 151 is shown with a flat top and bottom, any other shape that provides for smooth flow through a liquid and gas may be utilized. For example, an elliptical platform 151 with a vertical slot matching the contour of truss 150 is in keeping with the spirit of the invention. Any other shape may be used with more hydrodynamically shaped embodiments of the platform allowing for higher speed or smaller motor implementations.

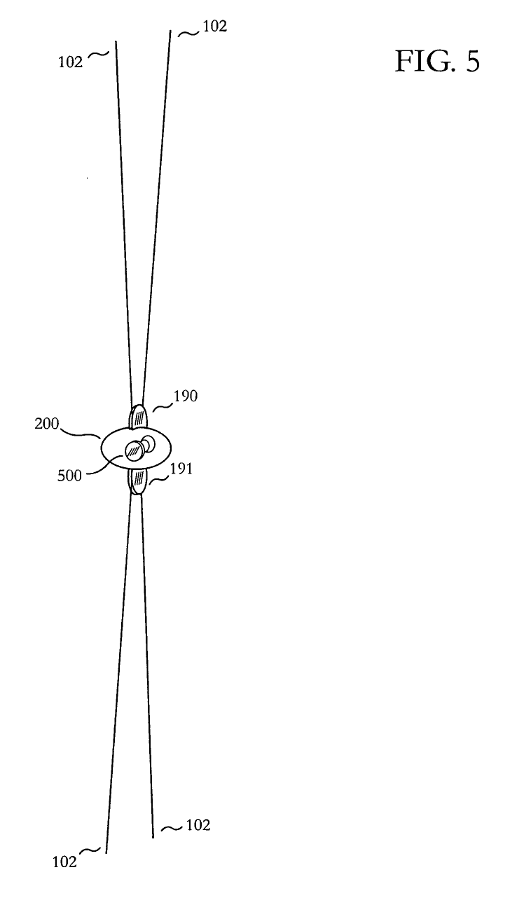

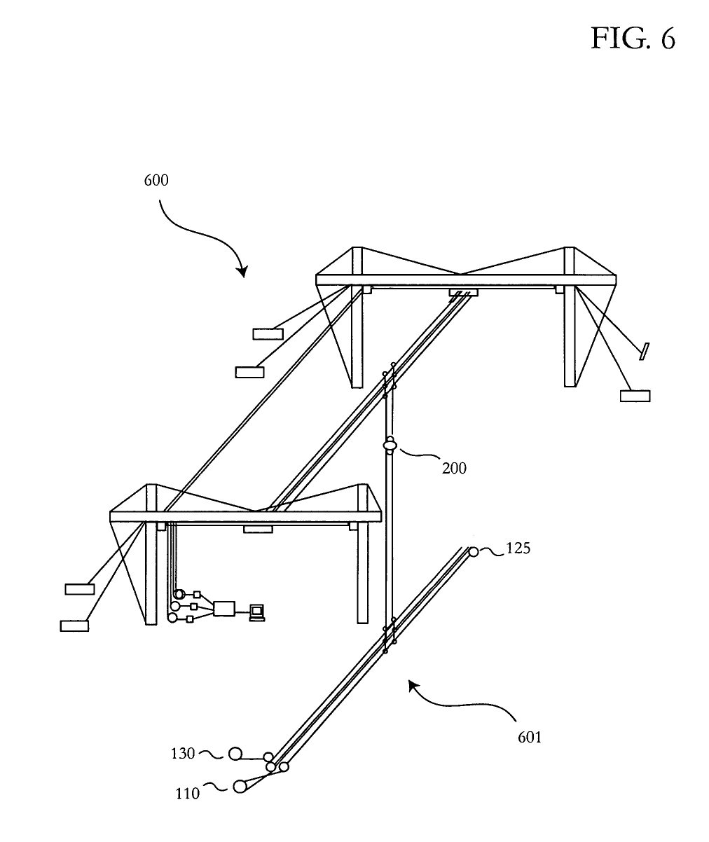

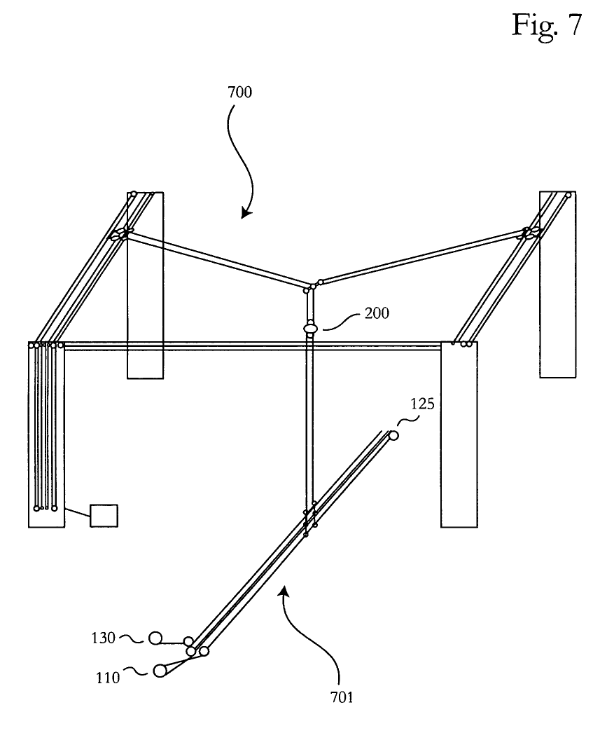

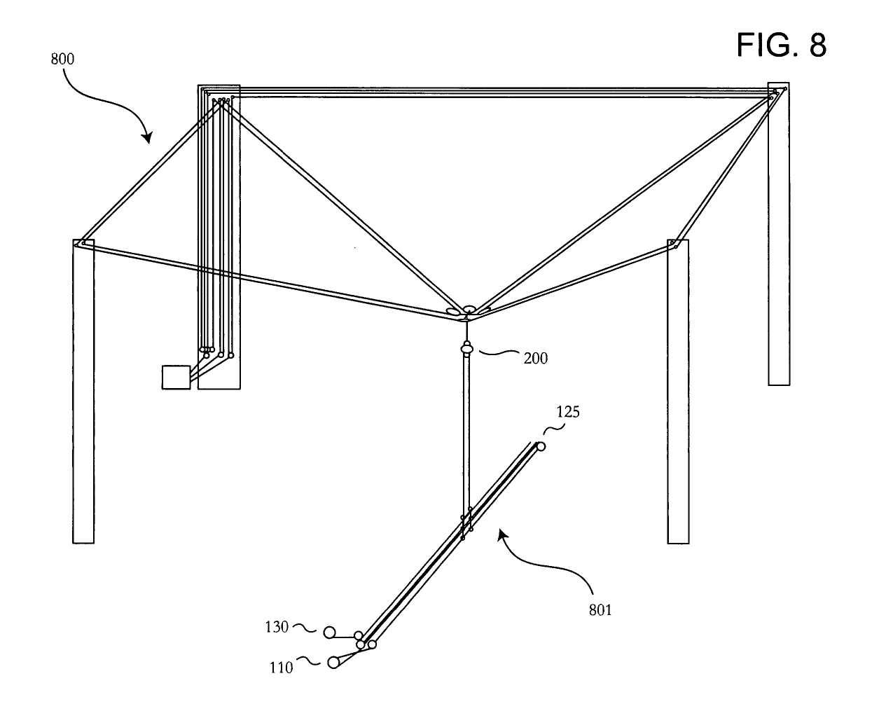

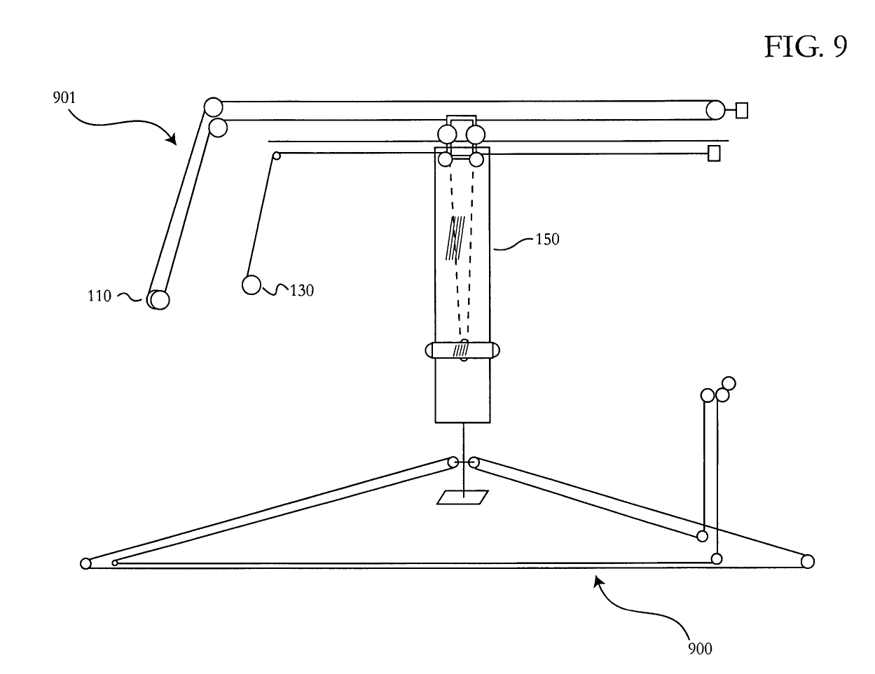

FIG. 5 shows an embodiment of the invention not using a truss. Platform 200 in this embodiment is an ellipsoid such as an oblate spheroid, sphere or elongated ellipsoid aligned with the planes formed by sheaves 190 and 191. In this embodiment there is no truss to provide hydrodynamic shielding of the upper or lower side of Z movement line 102. Sheaves 190 and 191 provide fins to stabilize platform 200 in this embodiment. Camera 500 is shown panned in the direction of travel to the right and slightly upward in the figure. Platform 200 in this embodiment is shown as a transparent enclosure. Electronic processing of images taken in any shape of platform 200 allows for aberration correction of the images and may account for the refraction indices of the enclosure, the liquid environment and the optical properties of the camera lenses themselves.

FIG. 6 shows an embodiment of the invention utilizing the reeving of U.S. patent application Ser. No. 10/368,137 now U.S. Pat. No. 6,886,471 in the upper environment area. The upper reeving 600 is described in the '471 patent which is hereby incorporated herein by reference. The lower reeving 601 is the lower reeving of FIG. 1. Moving the X movement line with X movement motor 110 and utilizing the X movement motor of the '471 patent in an equal amount yields X movement that is independent of Y axis and Z axis position of platform 200. In this embodiment Y axis movement is also possible (left to right on the written page). When moving in the Y axis, Z movement line from the lower reeving may inserted towards platform 200 to keep platform 200 at a given height as the platform traverses in the Y axis.

FIG. 7 shows an embodiment of the invention utilizing the reeving of U.S. patent application Ser. No. 10/604,667, filed Aug. 8, 2003 which is hereby incorporated herein by reference. The upper reeving 700 is described in the '667 application. The lower reeving is the lower reeving of FIG. 1. Moving the X movement line with the X movement motor 110 and utilizing the X movement motor of the '667 application in an equal amount yields X movement that is independent of the Y axis and Z axis position of platform 200. In this embodiment Y axis movement is also possible (left to right on the written page although the axis names are arbitrary in the horizontal plane). When moving in the Y axis, Z movement line from the lower reeving may inserted towards platform 200 to keep platform 200 at a given height as the platform traverses in the Y axis.

FIG. 8 shows an embodiment of the invention utilizing the reeving of U.S. patent application Ser. No. 10/709,994, filed Jun. 8, 2004 which is hereby incorporated herein by reference. The upper reeving 800 is described in the '994 application. The lower reeving is the lower reeving of FIG. 1. Moving the X movement line with the X movement motor 110 and utilizing the X movement motor of the '994 application in an equal amount yields X movement that is independent of the Y axis position of platform 200. In this embodiment Y axis movement is also possible (left to right on the written page although the axis names are arbitrary in the horizontal plane). When moving in the Y axis, Z movement line from the lower reeving may inserted towards platform 200 to keep platform 200 at a given height as the platform traverses in the Y axis. In addition, as the path of platform 200 is ellipsoidal using the top reeving 800, Z movement line using the lower reeving may be injected or retracted to or from platform 200 to account for the ellipsoidal path of upper reeving 800 when moving platform 200. Likewise the upper reeving can account for the ellipsoidal path by utilizing the Z movement motor described in the '994 patent application.

FIG. 9 shows the reeving in U.S. patent application Ser. No. 10/906,621, filed Feb. 27, 2005 as lower reeving 900. Upper reeving 901 is shown in the upper portion of FIG. 1 of this application. This embodiment shows that truss 150 may also be used in any of the embodiments including this one. The '621 patent application is hereby incorporated herein by reference.

Although there is no requirement to align upper and lower reevings along an axis as shown in FIGS. 6, 7, 8 or 9, doing so allows for independent axial movement as described above. For situations where the axes are skewed between the upper and lower reevings, Z movement line may be introduced or removed to and from platform 200 in order to keep the platform moving in a straight path, or at a given X, Y or Z position. Although platform 200 has been shown in FIGS. 6, 7, 8 for ease of illustration, a truss may be inserted between upper and lower reevings in any of the embodiments shown in order to created a hydrodynamic traversal guide for a platform as demonstrated in FIG. 9.

Although each of the lower reevings shown in FIGS. 6, 7 and 8 are of the embodiments described herein, the entire system may be flipped upside down in each of these figures in order to position the reeving described herein in the top location as has been demonstrated in FIG. 9. Alternatively, any of the reevings described in FIGS. 6, 7 and 8 and the reeving herein may be mixed and matched as needed for the application so long as tension is maintained on opposing sides of platform 200 in order to stabilize platform 200 when for example moving between environments. Independence of X and Z axes may be automatic and not require computer control of the upper or lower reeving, or may utilize computer control of one or both reevings in order to provide independence of the axes depending on the reevings utilized in both the upper and lower portions of the implementation.

While the invention herein disclosed has been described by means of specific embodiments and applications thereof, numerous modifications and variations could be made thereto by those skilled in the art without departing from the scope of the invention set forth in the claims.

What is claimed is:

1. A system for moving an object through multiple environments comprising:
a platform;
a plurality of sheaves coupled with opposing sides of said platform;
a first X movement line and a second X movement line configured to move opposing sides of said platform horizontally wherein an X position of said platform is independent of a Z-axis movement of said platform;
an X movement motor coupled with said first X movement line and said second X movement line wherein opposing sides of said platform move an equal distance when said X movement motor is rotated in a first direction;
a Z movement line configured to vertically move said platform wherein said Z movement line is coupled with said platform and wherein a Z position of said platform is independent of a X-axis movement of said platform; and,
a Z movement motor coupled with said Z movement line.

2. The system of claim 1 wherein said platform is shaped to allow ease of travel through both air and water when said platform is in either environment.

3. The system of claim 1 further comprising a truss having a high side coupled with said first X movement line and a low side coupled with said second X movement line wherein said truss is configured to move horizontally when said first and said second X movement line move.

4. The system of claim 3 wherein said platform is coupled with said truss allowing for vertical traversal of said truss by said platform.

5. The system of claim 4 wherein said platform is shaped to allow ease of travel through both air and water when said platform is in either environment.

6. The system of claim 1 wherein said platform comprises a camera.

7. The system of claim 1 wherein said platform comprises a forward facing bulbous enclosure.

8. The system of claim 1 wherein said platform comprises a rearward facing bulbous enclosure.

9. The system of claim 1 wherein said platform comprises a forward facing bulbous enclosure and rearward facing bulbous enclosure.

10. The system of claim 1 wherein said platform comprises an ellipsoidal enclosure.

11. The system of claim 10 wherein said ellipsoidal enclosure allows for a camera to pan in any direction.

12. The system of claim 10 wherein said ellipsoidal enclosure comprises sheaves that act as fins to stabilize the direction of travel of said platform.

13. The system of claim 1 further comprising a dampener mounted on said platform wherein said dampener is selected from the group consisting of an active dampener and a passive dampener.

14. The system of claim 13 wherein said dampener is coupled with a camera.

15. A method of moving an object through multiple environments comprising:
coupling a first X movement line and a second X movement line with a platform;
coupling an X movement motor to said first X movement line and said second X movement line;
coupling a Z movement line with opposing sides of said platform; and,
coupling a Z movement motor to said Z movement line.

16. The method according to claim 15 further comprising:
moving said platform in an X-axis direction by moving said first X movement line and said second X movement line; and,
moving said platform in a Z-axis direction by moving said Z movement line.

17. The method according to claim 15 further comprising:
controlling platform movement with a computer system.

18. A system for moving an object through multiple environments comprising:
means for coupling a first X movement line and a second X movement line with a platform;
means for coupling an X movement motor to said first X movement line and said second X movement line;
means for coupling a Z movement line with opposing sides of said platform; and,
means for coupling a Z movement motor to said Z movement line.

19. The system according to claim 18 further comprising:
means for moving said platform in an X-axis direction by moving said first X movement line and said second X movement line; and,
means for moving said platform in a Z-axis direction by moving said Z movement line.

20. The system according to claim 18 further comprising:
means for controlling platform movement with a computer system.
